(19) United States
(12) Patent Application Publication
(10) Pub. No.: US 2004/0237699 A1
(43) Pub. Date: Dec. 2, 2004

(54) Drive cable and a cable-operated window regulator

(76) Inventors: Kimihiro Kinoshita, Kanagawa (JP); Satoshi Takeda, Tokyo (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/742,748

(22) Filed: Dec. 23, 2003

(30) Foreign Application Priority Data
Dec. 25, 2002 (JP) 2002-374882

(51) Int. Cl. F16C 1/22

(52) U.S. Cl. 74/502.6

(57) ABSTRACT

A drive cable includes a barrel nipple fixed on an end of the drive cable, wherein an axis of the barrel nipple extends in a direction perpendicular to a longitudinal direction of the drive cable; and a cable protection cover which covers a portion of the drive cable adjacent to the barrel nipple,

wherein the barrel nipple and the cable protection cover are formed integral with each other.

### BACKGROUND OF THE INVENTION

1. Field of the Invention

The present invention relates to a drive cable via which force is exerted to control or operate a mechanism, and further relates to a cable-operated window regulator for a vehicle which includes the drive cable.

2. Description of the Related Art

A drive cable, or a strong wire, is used in various fields as a flexible device for transferring power to a driven member of a mechanism. In the field of vehicles, one or more drive cable is often used as a component of a mechanism such as a cable-operated window regulator or a lock (e.g., a door lock, a hood lock, a back door or a tailgate). In any of these fields, electrical or manual power which is supplied to an operational member is transferred to a driven member via a flexible drive cable to control or operate a mechanism. A drive cable is often provided at each end thereof with a barrel nipple, the axis of which extends in a direction perpendicular to the longitudinal direction of the drive cable to join the opposite ends of the drive cable to an operational member and a driven member, respectively. The two barrel nipples fixed on the opposite ends of the drive cable are fitted in two cable end holding portions to be held thereby which are formed on an operational member and a driven member, respectively.

In conventional cable-operated window regulators for a vehicle, a window glass is fixed to a slider base which is guided in a vertical direction by a guide rail, and the slider base is moved up and down via a pair of drive cables to raise and lower the window glass. The pair of drive cables are installed from the slider base to a reversible winding unit via an upper cable guide member and a lower cable guide member, respectively, which are positioned in a vehicle's door or gate (e.g., a side door or a tailgate). Driving the reversible winding unit to wind and rewind the pair of drive cables causes the window glass to move up and down. A conventional drive cable which is used as each drive cable for such conventional cable-operated window regulators is usually formed so that the portion of the drive cable which extends between the slider base and the upper or lower cable guide member is a bare cable portion, which is covered with no sheath. There is a possibility of this bare cable portion being scratched during the operation installing the barrel nipple, which is fixed on one end of the drive cable, to a cable end holding portion of an operational member or a drive member. If the bare cable portion is scratched and damaged, the damaged portion deteriorates the strength of the drive cable with time, thus becoming a main cause of decreasing durability of the cable-operated window regulator.

A method of increasing the mechanical strength of the joint between a barrel nipple and the associated end of the drive cable on which the barrel nipple is fixed by swaging a peripheral end of the barrel nipple is known in the art. However, this requires an extra operation, thus increasing the production cost.

### Summary of the Invention

The present invention provides a drive cable having a barrel nipple at one end or each end of the drive cable, wherein a portion of the drive cable adjacent to the barrel nipple is prevented from being damaged.

The present invention provides a cable-operated window regulator which is constructed to prevent the bare cable portion of one or more drive cable of the cable-operated window regulator from being damaged to thereby increase durability of the cable-operated window regulator.

According to an aspect of the present invention, a drive cable is provided, including a barrel nipple fixed on an end of the drive cable, wherein an axis of the barrel nipple extends in a direction perpendicular to a longitudinal direction of the drive cable; and a cable protection cover which covers a portion of the drive cable adjacent to the barrel nipple. The barrel nipple and the cable protection cover are formed integral with each other.

It is desirable for the cable protection cover to be a cylindrical portion fitted on the drive cable.

It is desirable for the cylindrical portion to include a first cylindrical portion formed integral with the barrel nipple; and a second cylindrical portion formed integral with the first cylindrical portion to be positioned on the opposite side of the first cylindrical portion from the barrel nipple. A diameter of the second cylindrical portion is smaller than a diameter of the first cylindrical portion.

It is desirable for the barrel nipple and the cable protection cover to be formed on the one end of the drive cable by insertion molding.

It is desirable for the barrel nipple and the cable protection cover to be made of metal.

The drive cable can be a twisted steel wire.

In another embodiment, a cable-operated window regulator for a vehicle is provided, including a slider base fixed to a window glass; a cable-end holding portion formed on the slider base; a drive cable, one end of which is supported by the cable-end holding portion, the drive cable extending from the cable-end holding portion to a cable guide member; a barrel nipple fixed on the one end of the drive cable, wherein an axis of the barrel nipple extends in a direction perpendicular to a longitudinal direction of the drive cable; and a cable protection cover which covers a portion of the drive cable adjacent to the barrel nipple. The cable-end holding portion includes a barrel nipple support portion which holds opposite ends of the barrel nipple. The barrel nipple and the cable protection cover are formed integral with each other.

The cable-end holding portion can include a pair of parallel support portions which are formed by bending a metal portion of the cable-end holding portion to have a substantially U-shape cross section. The pair of parallel support portions serve as the barrel nipple support portion to hold the opposite ends of the barrel nipple, respectively.

It is desirable for the barrel nipple support portion to include at least two barrel nipple support portions which are offset from each other in a direction perpendicular to outer and inner surfaces of the window glass.

It is desirable for the cable protection cover to include a cylindrical portion fitted on the drive cable.

It is desirable for the cylindrical portion to include a first cylindrical portion formed integral with the barrel nipple; and a second cylindrical portion formed integral with the first cylindrical portion to be positioned on the opposite side of the first cylindrical portion from the barrel nipple. A diameter of the second cylindrical portion is smaller than a diameter of the first cylindrical portion.

It is desirable for a pair of coaxial holes to be formed on the barrel nipple support portion, the opposite ends of the barrel nipple being fitted in the pair of coaxial holes, respectively, so that the barrel nipple can rotate freely about an axis of the pair of coaxial holes.

The cable guide member can be a pulley.

The present disclosure relates to subject matter contained in Japanese Patent Application No.2002-374882 (filed on Dec. 25, 2002) which is expressly incorporated herein by reference in its entirety.

### BRIEF DESCRIPTION OF THE DRAWINGS

The invention will be discussed below in detail with reference to the accompanying drawings, in which:

FIG. 1 is a front elevational view of an embodiment of a cable-operated window regulator according to the present invention;

FIG. 2 is an enlarged front elevational view of a portion of the cable-operated window regulator shown in FIG. 1 which includes a slider base;

FIG. 3 is a cross sectional view taken along III-III line in FIG. 2;

FIG. 4 is a cross sectional view taken along IV-IV line in FIG. 2;

FIG. 5 is a cross sectional view taken along V-V line in FIG. 2;

FIG. 6 is a side elevational view of a portion of the cable-operated window regulator shown in FIG. 1, viewed in the direction of an arrow VI shown in FIG. 2;

FIG. 7 is a side elevational view of a portion of the cable-operated window regulator shown in FIG. 1, viewed in the direction of an arrow VII shown in FIGS. 1 and 2;

FIG. 8 is a plan view of one end of a drive cable shown in FIG. 1;

FIG. 9 is a cross sectional view taken along IX-IX line in FIG. 8; and

FIG. 10 is an exploded perspective view of a portion of the cable-operated window regulator shown in FIG. 1.

### DESCRIPTION OF THE PREFERRED EMBODIMENT

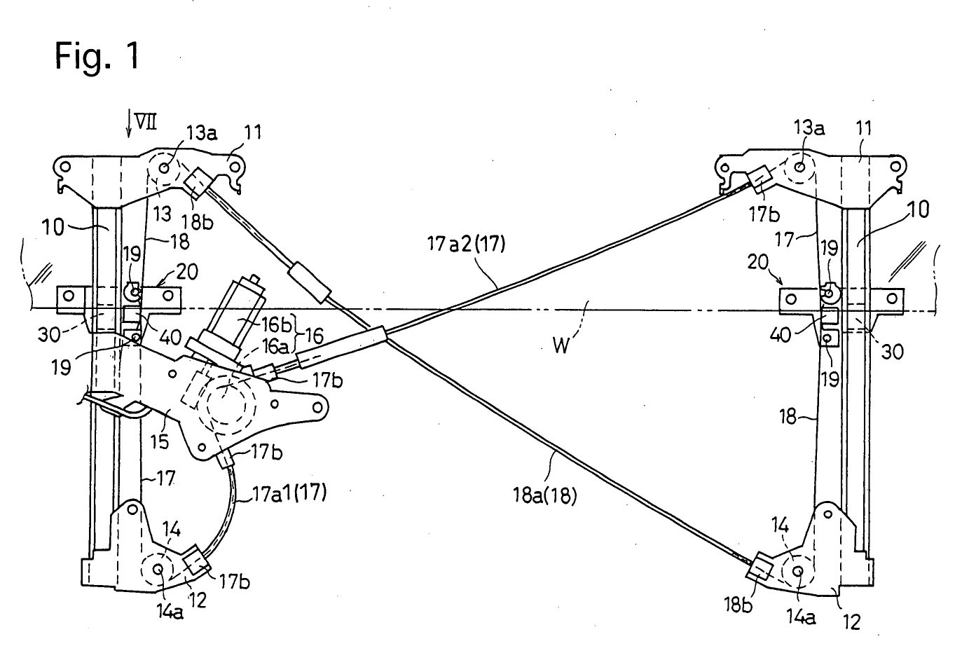

FIG. 1 shows an embodiment of a cable-operated window regulator for a vehicle according to the present invention, which is applied to a back door at the rear end of the vehicle.

The cable-operated window regulator is incorporated in a tailgate of a vehicle (not shown) whose right or left side edge is hinged. The cable-operated window regulator is provided with a pair of parallel guide rails 10 which are fixed to an inner panel of the tailgate to extend vertically (vertically as viewed in FIG. 1) and to be bilaterally positioned apart from each other in a widthwise direction of the tailgate (horizontal direction as viewed in FIG. 1). The cable-operated window regulator is provided with a pair of sliders 30 which are engaged with the pair of guide rails 10 to be slidably guided thereby along a longitudinal direction of the pair of guide rails 10, respectively. A pair of horizontally-elongated slider bases 20 are fixed to outer surfaces of the pair of sliders 30, respectively, while the lower edge of the window glass W is fixed to outer surfaces of the pair of slider bases 20.

The cable-operated window regulator is provided at upper and lower ends of each guide rail 10 with an upper bracket 11 and a lower bracket 12, respectively. The upper bracket 11 and the lower bracket 12 are welded to the upper and lower ends of each guide rail 10, respectively. An upper guide pulley (upper cable guide member) 13 is provided on each upper bracket 11 to be freely rotatable on a pin 13a fixed to the upper bracket 11, while a lower guide pulley (lower cable guide member) 14 is provided on each lower bracket 12 to be freely rotatable on a pin 14a fixed to the lower bracket 12. All the four guide pulleys 13 and 14 are positioned inwardly between the pair of guide rails 10.

The cable-operated window regulator is provided with a winding unit bracket 15 which is welded at one end thereof to the left guide rail 10 as shown in FIG 1. A reversible winding unit 16 which includes a winding drum 16a and a reversible motor 16b is fixed to a middle portion of the winding unit bracket 15. The cable-operated window regulator is provided with two window drive cables for raising and lowering the window glass W: a first drive cable 17 and a second drive cable 18. The first drive cable 17 is wound around the winding drum 16a, and one end of the first drive cable 17 is connected to the left slider base 20 via the lower guide pulley 14 that is fixed at the lower end of the left guide rail 10 while the other end of the first drive cable 17 is connected to the right slider base 20 via the upper guide pulley 13 that is fixed to the upper end of the right guide rail 10 as viewed in FIG. 1. One end of the second drive cable 18 is connected to the left slider base 20 via the upper guide pulley 13 that is fixed to the upper end of the left guide rail 10, while the other end of the second drive cable 18 is connected to the right slider base 20 via the lower guide pulley 14 that is fixed to the lower end of the right guide rail 10 as viewed in FIG. 1. Accordingly, in the present embodiment of the cable-operated window regulator, the first drive cable 17 and the second drive cable 18 intersect each other in the shape of a cross (X) between the pair of guide rails 10.

Accordingly, rotating the winding drum 16a in forward and reverse directions by the reversible motor 16b causes the first drive cable 17 to be reeled on and off the winding drum 16a on one side of the first drive cable 17, and at the same time, causes the first drive cable 17 to be reeled off and on the winding drum 16a on the other side of the first drive cable 17, respectively. Consequently, the pair of slider bases 20, which are slidably guided by the pair of guide rails 10 to be freely movable along the pair of guide rails 10 and are also connected to each of the first and second drive cables 17 and 18, simultaneously move up or down in the same direction to raise and lower the window glass W that is fixed to the pair of slider bases 20. The first drive cable 17 is generally composed of two cables: a first cable extending between the left slider base 20 and the winding drum 16a, and a second cable extending between the right slider base 20 and the winding drum 16a.

As clearly seen in FIGS. 8 through 10, a barrel nipple 19 is provided at each of the opposite ends of the first drive cable 17 and are connected to the left slider base 20 and the right slider base 20, respectively. Likewise, a barrel nipple 19 is provided at each of the opposite ends of the second drive cable 18 and are connected to the left slider base 20 and the right slider base 20, respectively. Each barrel nipple 19 is made of metal or a similar material. The axis of each barrel nipple 19 extends in a direction perpendicular to a longitudinal direction of the first drive cable 17 or the second drive cable 18. The first drive cable 17 is provided thereon adjacent to each barrel nipple 19 thereof with a corresponding cable protection cover (cylindrical portion) 19a, respectively. Likewise, the second drive cable 18 is provided thereon adjacent to each barrel nipple 19 thereof with a corresponding cable protection cover 19a, respectively. Each cable protection cover 19a is integrally formed with the associated barrel nipple 19 to sheathe the portion (bare portion) of the associated drive cable 17 or 18 adjacent to the associated barrel nipple 19. Each of the first drive cable 17 and the second drive cable 18 is, e.g., a twisted steel wire. Each barrel nipple 19 and the associated cable protection cover 19a are integrally formed via casting. This cast consisting of one barrel nipple 19 and one cable protection cover 19a is fixed on each end of the first drive cable 17 and also each end of the second drive cable 18 so that the cable protection cover 19a is swaged after the associated end of the drive cable 17 or 18 is inserted into the cable protection cover 19a. Each barrel nipple 19 and the associated cable protection cover 19a can be made of metal such as an aluminum alloy or a magnesium alloy. A portion of the first drive cable 17 between the left lower bracket 12 and the winding unit bracket 15 is covered by a first sheath 17a1, while another portion of the first drive cable 17 between the right upper bracket 11 and the winding unit bracket 15 is covered by a second sheath 17a2. Two end brackets 17b which are fixed to the left lower bracket 12 and the winding unit bracket 15 are fixed to the opposite ends of the first sheath 17a1, respectively. Likewise, another two end brackets 17b which are fixed to the winding unit bracket 15 and the right upper bracket 11 are fixed to the opposite ends of the second sheath 17a2, respectively. Accordingly, a portion of the first drive cable 17 between the left lower bracket 12 and the left slider base 20 is a bare cable portion, while another portion of the drive cable 17 between the right upper bracket 11 and the right slider base 20 is a bare cable portion. A portion of the second drive cable 18 between the left upper bracket 11 and the right lower bracket 12 is covered by a third sheath 18a. Two end brackets 18b which are fixed to the left upper bracket 11 and the right lower bracket 12 are fixed to the opposite ends of the third sheath 18a, respectively. Accordingly, a portion of the second drive cable 18 between the right lower bracket 12 and the right slider base 20 is a bare cable portion, while another portion of the second drive cable 18 between the left upper bracket 11 and the left slider base 20 is a bare cable portion.

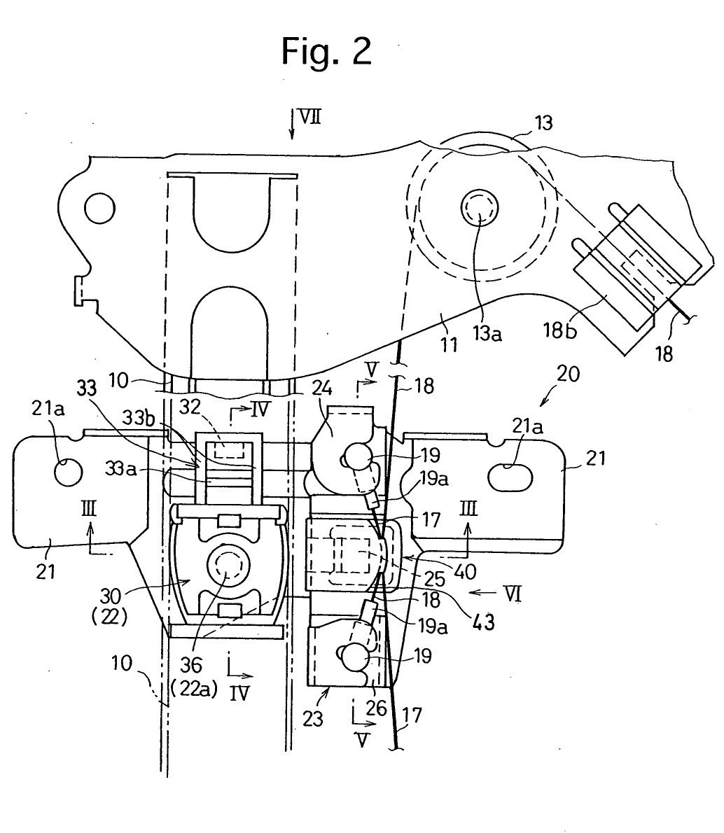

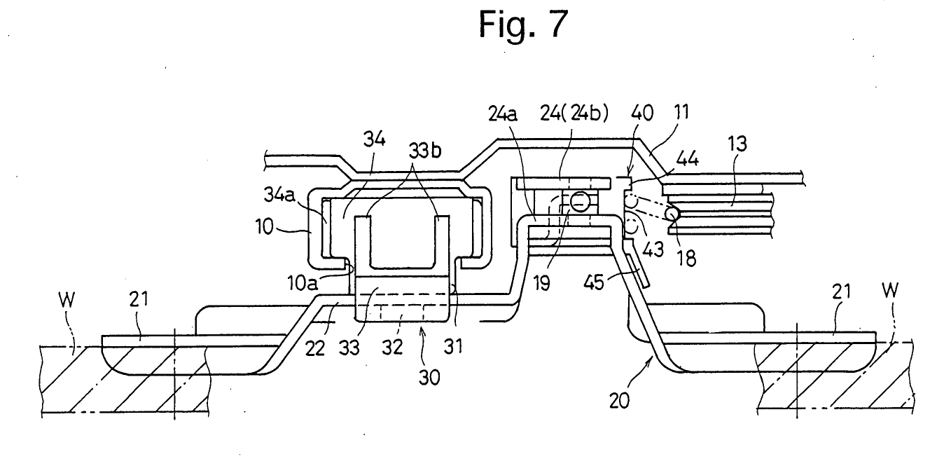

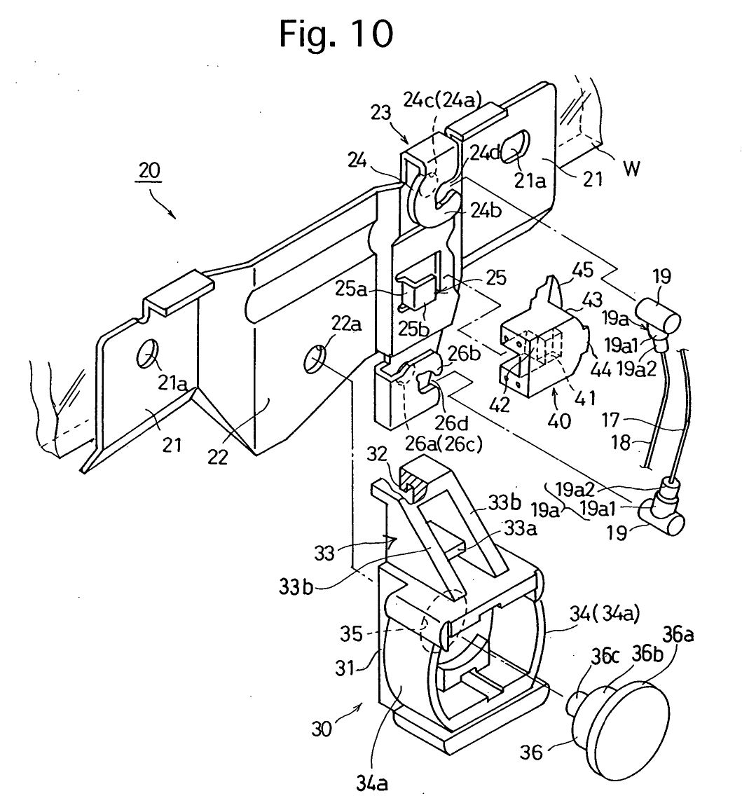

The left slider base 20 and the right slider base 20 are substantially symmetrical, and accordingly have substantially the same shape and size. Each slider base 20 is made of metal and are press-formed. As clearly shown in FIGS. 2 and 10, each slider base 20 is provided on horizontally opposite sides thereof with a pair of glass holding plate portions 21 which are positioned on horizontally opposite sides of the associated guide rail 10. A bolt insertion hole 21a is formed on each glass holding plate portion 21. Each slider base 20 is provided, between the pair of glass holding plate portions 21 on an inner surface of the slider base 20 that faces the associated guide rail 10 (on a surface of the slider base 20 on the opposite side thereof from the window glass W), with a slider holding surface 22 which projects inwards, toward the associated guide rail 10 (upwards as viewed in FIG. 7), from a plane in which the pair of glass holding plate portions 21 lie. Each slider base 20 is further provided between the pair of glass holding plate portions 21 thereof with a cable-end holding portion 23 which projects further inwards from a plane on which the slider holding surface 22 lies.

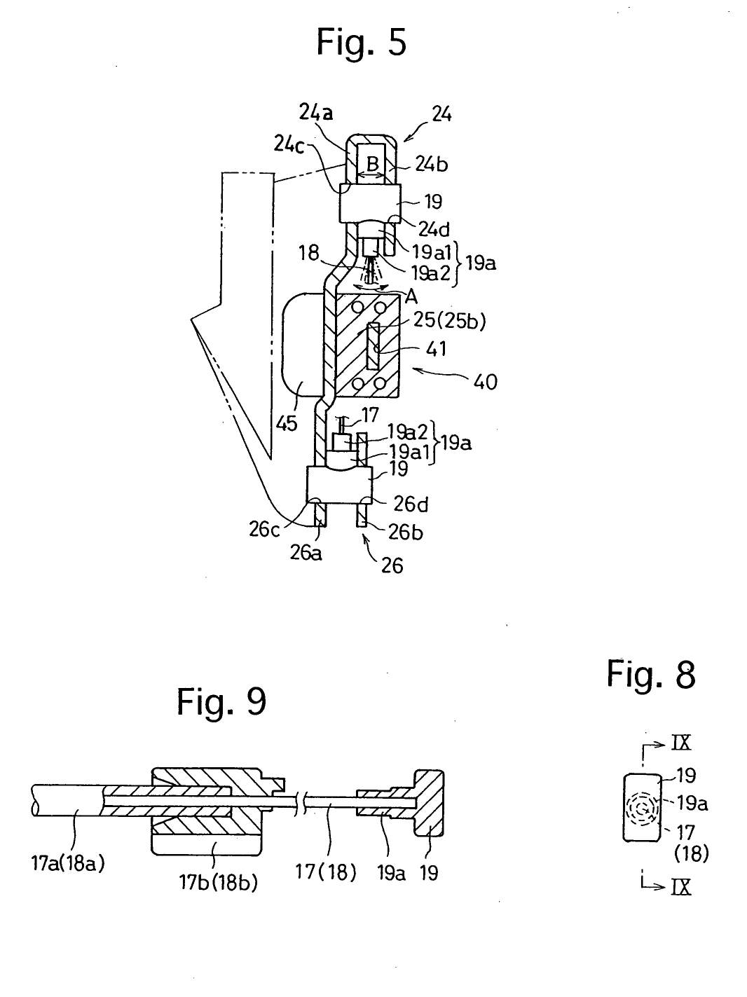

The cable-end holding portion 23 of each slider base 20 is provided with an upper cable-end hook portion 24, a synthetic piece holding portion 25 and a lower cable-end hook portion 26, in that order from top to bottom of the cable-end holding portion 23. As clearly shown in FIGS. 5 and 10, the upper cable-end hook portion 24 of each slider base 20 is formed so that a portion of the slider base 20 is bent to have a substantially U-shape cross section to thereby form a pair of support portions (outer and inner support portions) 24a and 24b which are parallel to each other. The outer support portion 24a, which is adjacent to the window glass W, is provided with an outer support hole 24c in which one of the axially opposite ends of the associated barrel nipple 19 is fitted. The inner support portion 24b has a substantially C-shape and has an inner support hole 24d in which the other end of the axially opposite ends of the associated barrel nipple 19 is fitted. The outer support hole 24c and the inner support hole 24d are aligned in a direction perpendicular to outer and inner surfaces of the window glass W. The inner support portion 24b is provided with a radial slit extending in a radial direction of the inner support hole 24d so that the associated end of the associated barrel nipple 19 can be inserted into the inner support hole 24d through the slit in a direction orthogonal to the axis of the pair of support holes 24c and 24d. Accordingly, the axially opposite ends of the barrel nipple 19 which is fixed on one end of the first drive cable 17 or the second drive cable 18 reaching the upper cable-end hook portion 24 from below are engaged in the pair of support portions 24a and 24b to be supported thereby, respectively.

As shown in FIGS. 5 and 10, in each cable protection cover 19a, the portion of the cable protection cover 19a which covers one end of the associated drive cable 17 or 18 there along is swaged to be fixed integral therewith. Specifically, in each cable protection cover 19a, the portion of the cable protection cover 19a adjacent to a bare portion of the associated drive cable 17 or 18 is swaged to serve as a swaged portion 19a2, while the remaining portion of the cable protection cover 19a, that is positioned adjacent to the associated barrel nipple 19, is not swaged to serve as a non-swaged portion 19a1 so that a stepped portion is formed on the cable protection cover 19a between the swaged portion 19a2 and the non-swaged portion thereof 19a1. The non-swaged portion 19a1, which is cast to exact dimensions, is positioned between the pair of support portions (24a and 24b, or 26a and 26c) of the upper or lower cable-end hook portion 24 or 26 with a minimum clearance to position the associated end of the first or second drive cable 17 or 18 relative to the upper or lower cable-end hook portion 24 or 26 with a high positioning accuracy. This structure prevents each barrel nipple 19 from grating or rattling (in directions shown by arrows B in FIG. 5) due to the swinging of the first or second drive cable 17 or 18 (in directions shown by arrows A in FIG. 5). Moreover, the strength of the joint between each barrel nipple 19 and the associated cable protection cover 19a can be increased by securing a sufficient thickness of the joint. The swaged portion 19a2 is swaged to hold the first drive cable 17 (or second drive cable 18) which is inserted into the swaged portion 19a2. Alternatively, the aforementioned stepped portion on the cable protection cover 19a between the swaged portion 19a2 and the non-swaged portion thereof 19a1 can be formed by casting, rather than swaging. A similar effect can also be expected in this alternative case.

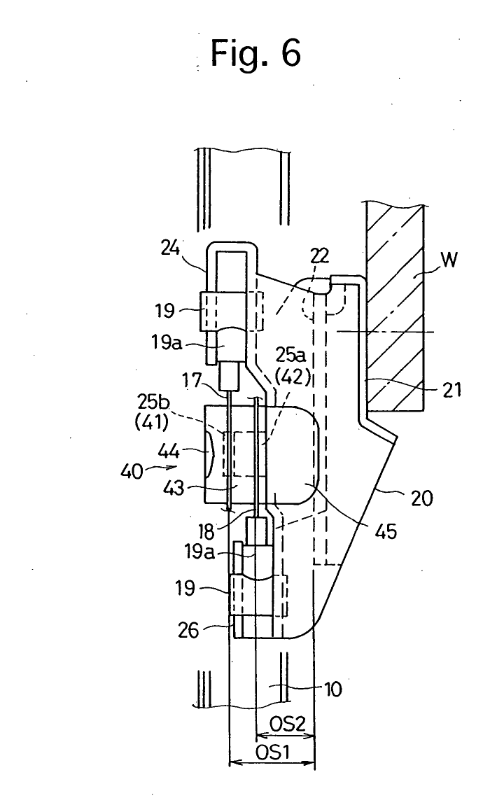

Similar to the upper cable-end hook portion 24 on each slider base 20, the lower cable-end hook portion 26 is formed so that a portion of the slider base 20 is bent to have a substantially U-shape cross section to thereby form a pair of support portions (outer and inner support portions) 26a and 26b which are parallel to each other. The outer support portion 26a, which is adjacent to the window glass W, is provided with an outer support hole 26c in which one of the axially opposite ends of the associated barrel nipple 19 is fitted. The inner support portion 26b has a substantially C-shape to have an inner support hole 26d in which the other end of the axially opposite ends of the associated barrel nipple 19 is fitted. The outer support hole 26c and the inner support hole 26d are aligned in a direction perpendicular to outer and inner surfaces of the window glass W. The inner support portion 26b is provided with a radial slit extending in a radial direction of the inner support hole 26d so that the associated barrel nipple 19 can be inserted into the inner support hole 26d through the slit in a direction orthogonal to the axis of the pair of support holes 26c and 26d. Accordingly, the axially opposite ends of the barrel nipple 19 which is fixed on one end of the first drive cable 17 or the second drive cable 18 reaching the lower cable-end hook portion 26 from above are engaged in the pair of support portions 26a and 26b to be supported thereby, respectively. Therefore, the first drive cable 17 and the second drive cable 18 intersect each other in the immediate area of each slider base 20 between the upper cable-end hook portion 24 and the lower cable-end hook portion 26 as viewed in a direction of the thickness of the tailgate (direction orthogonal to the surface of the drawing of FIG. 1). The respective positions of the upper cable-end hook portion 24 and the lower cable-end hook portion 26 are offset from each other in a direction perpendicular to outer and inner surfaces of the window glass W so that the first drive cable 17 and the second drive cable 18 intersect each other as viewed in a direction of the thickness of the tailgate without contacting with each other (see FIGS. 5 and 6). The length of the cable protection cover 19a is determined so that a bare cable portion of the first drive cable 17 (or the second drive cable 18) does not make contact with any edges of the inner support portion 24b (or 26b) when the barrel nipple 19 is engaged in the outer support hole 24c (or 26c) after being inserted into the inner support hole 24d (or 26d).

Each slider base 20 is provided on the slider holding surface 22 thereof with a through hole 22a through which the associated slider 30, which is slidably engaged with the associated guide rail 10 to be freely movable therealong, is fixed to the slider holding surface 22 with a rivet 36. As clearly shown in FIG. 10, each slider 30 is provided with a neck portion 31, an extension portion 33 and a sliding portion 34 which are molded as a single piece of a synthetic resin. The neck portion 31 of each slider 30 is formed to correspond to a narrow-width opening 10a (see FIG. 7) of the associated guide rail 10. The extension portion 33 of each slider 30 extends along the slider holding surface 22, and is provided on the top thereof with a hook portion 32 with which the slider 30 can be hooked on an upper edge of the slider holding surface 22. The sliding portion 34 is engaged in the associated guide rail 10 to be slidably guided there along, and is provided on opposite surfaces of the sliding portion 34 with a pair of semi-cylindrical surfaces 34a which bulge in opposite directions away from each other to be in sliding contact with opposed inner surfaces of the associated guide rail 10, respectively. The pair of semi-cylindrical surfaces 34a are resiliently deformed to ensure a smooth sliding movement of the sliding portion 34 relative to the associated guide rail 10 when each sliding portion 34 moves along the associated guide rail 10. The sliding portion 34 is provided at a center thereof with a through hole 35 in which the rivet 36 is engaged. More specifically, as shown in FIGS. 4 and 10, the rivet 36 has a head portion 36a, a middle cylindrical portion 36b and an end pin portion 36c, wherein the middle cylindrical portion 36b of each rivet 36 can be fitted in the through hole 35 of the associated slider 30 while the end pin portion 36c can be fitted in the associated through hole 22a.

The through hole 35 (the rivet 36) and the hook portion 32 of each slider 30 are vertically apart from each other so that the through hole 35 and the associated through hole 22a are aligned when the hook portion 32 is hooked on an upper edge of the slider holding surface 22. In this state where the through hole 35 and the associated through hole 22a are aligned, the middle cylindrical portion 36b of the rivet 36 is fitted into the through hole 35 while the end pin portion 36c is fitted into the associated through hole 22a. The tip of the end pin portion 36c extends through the slider base 20 via the through hole 22a to project outwards therefrom, and this projecting portion of the end pin portion 36c is riveted and swaged to fix the slider 30 to the associated slider base 20. Accordingly, each slider 30 is fixed to the associated slider base 20 by the hook portion 32 and the rivet 36, i.e., at two points vertically apart from each other. In each slider 30, the extension portion 33 connects the sliding portion 34 with the hook portion 32, and is provided with a pair of reinforcement ribs 33b and a horizontal connecting piece 33a which is positioned between the pair of reinforcing ribs 33b to connect the pair of reinforcing ribs 33b. The pair of reinforcing ribs 33b extend in a direction orthogonal to the outer and inner surfaces of the window glass W. The pair of reinforcement ribs 33b reliably prevent the slider 30 from coming off the associated slider base 20. In the particular type of cable-operated window regulator such as the present embodiment of the cable-operated window regulator in which a window glass (W) and a slider (30) are fixed to an outer surface and an inner surface of one slider base (20), respectively, each slider 30 is acted upon by a force to move the slider 30 away from the associated slider base 20 because the slider holding surface 22 (and the sliding portion 34) and the upper cable-end hook portion 24 (and the lower cable-end hook portion 26) are horizontally offset from each other (and because the sliding portion 34 and the window glass W are offset from each other in a direction perpendicular to outer and inner surfaces of the window glass W). This structure would cause the rivet 36 from becoming wobbly with time to a degree each slider 30 may come off the slider 20 if each slider 30 is not provided with either the hook portion 32 or the pair of reinforcement ribs 33. Against the aforementioned force acted on the slider 30, the hook portion 32 and the pair of reinforcement ribs 33 of each slider 30 ensure stability of the slider 30 for a long period of time. In FIG. 6, the amount of offset of the upper cable-end hook portion 24 (the first drive cable 17) from the slider holding surface 22 and the amount of offset of the lower cable-end hook portion 26 (the second drive cable 18) from the slider holding surface 22 are indicated by “OS1” and “OS2”, respectively.

The synthetic-piece holding portion 25 of each slider base 20 is shaped as a hook having an L-shaped cross section which includes a root portion 25a and an end portion 25b. The root portion 25a extends perpendicularly to a plane in which the slider holding surface 22 lies, while the end portion 25b extends parallel to the slider holding surface 22.

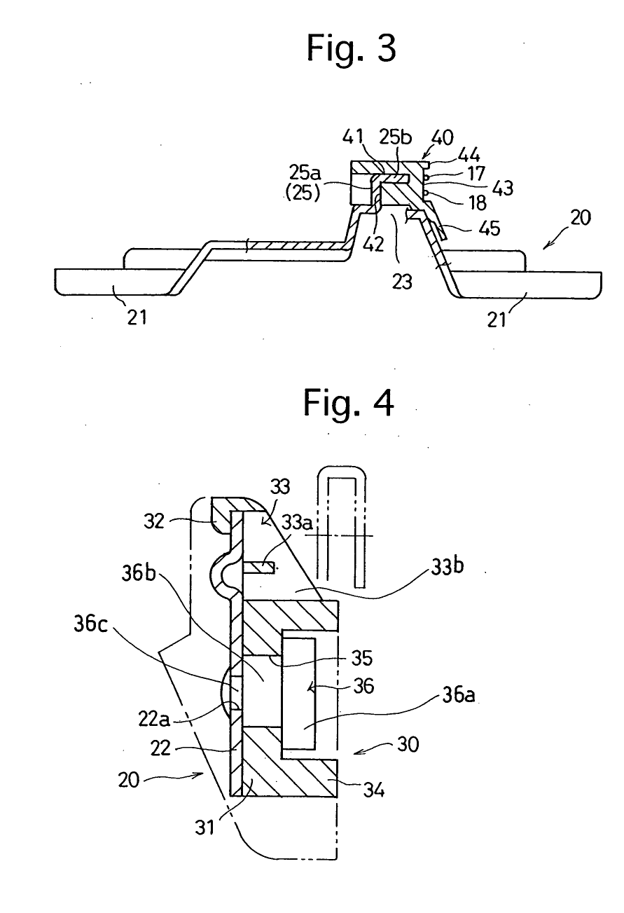

A cable guide piece (synthetic piece) 40 made of synthetic resin is fixed to the synthetic piece holding portion 25 of each slider base 20 to be supported thereby. The cable guide piece 40 on each slider base 20 is engaged with the first drive cable 17 and the second drive cable 18 so that each of the first drive cable 17 and the second drive cable 18 does not contact with any part of the slider base 20. Each cable guide piece 40 is provided with a bottomed engaging hole 41 (see FIGS. 3 and 5) in which the end portion 25b of the synthetic piece holding portion 25 is fitted, and a contacting surface 42 (see FIG. 3) to which the root portion 25a of the synthetic piece holding portion 25 contacts. Each cable guide piece 40 is provided on an outer surface thereof with a semi-cylindrical surface 43, the axis of which extends in a direction orthogonal to outer and inner surfaces of the window glass W. Each cable guide piece 40 is provided at opposite ends of the semi-cylindrical surface 43 with a holding projection 44 and a cable-protective beveled tongue 45, respectively. The holding projection 44 prevents respective bare portions of the first drive cable 17 and the second drive cable 18 which lie on the semi-cylindrical surface 43 from coming off the semi-cylindrical surface 43. The cable-protective beveled tongue 45 is positioned along an inclined surface of the associated slider base 20 which extends between one of the pair of glass holding plate portions 21 to the cable-end holding portion 23 (see FIG. 3). The positional relationship between the semi-cylindrical surface 43 and the contacting surface 42 (the root portion 25a) of each cable guide piece 40 is determined so that the root portion 25a can receive the force acting on the cable guide piece 40 which is produced by the pressure of the first drive cable 17 and the second drive cable 18 against the semi-cylindrical surface 43. Namely, the positional relationship between the semi-cylindrical surface 43 and the contacting surface 42 (the root portion 25a) of each cable guide piece 40 is determined so that the cable guide piece 40 is held tight between the root portion 25a and the first and second drive cables 17 and 18. Accordingly, the cable guide piece 40 does not come off the synthetic piece holding portion 25 because the end portion 25b thereof is fitted in the bottomed engaging hole 41. The position of each cable guide piece 40 relative to the associated slider base 20 is determined so that a portion of the drive cable 17 or 18 which extends from the upper cable-end hook portion 24 to the lower guide pulley 14 via the semi-cylindrical surface 43 does not contact with any part of the associated slider base 20, nor with the lower cable-end hook portion 26 thereof, and so that a portion of the drive cable 17 or 18 which extends from the lower cable-end hook portion 26 to the upper guide pulley 13 via the semi-cylindrical surface 43 does not contact with any part of the associated slider base 20, nor with the upper cable-end hook portion 24 thereof.

When the above illustrated embodiment of the cable-operated window regulator that has the above described structures are assembled, each slider 30 is fixed to the associated slider base 20 by firstly inserting the end pin portion 36c of one rivet 36 into the through hole 22a through the through hole 35, and subsequently swaging the end pin portion 36c in a state where the hook portion 32 is hooked on an upper end of the slider base 20 (slider holding surface 22). Thereafter, each slider 30 is engaged in the associated guide rail 10 to be freely slidable there along with the neck portion 31 projecting out of the narrow-width opening 10a (shown in FIG. 7). The window glass W is fixed to outer surfaces of the pair of glass holding plate portions 21 of each slider base 20.

Subsequently, for each slider base 20, in a state where the cable guide piece 40 is fixed to the synthetic piece holding portion 25 with the end portion 25b thereof being fitted in the bottomed engaging hole 41 and with the root portion 25a contacting with the contacting surface 42, the barrel nipple 19 which is fixed on an end of the drive cable 17 (or 18) led to the upper cable-end hook portion 24 from below is engaged in the pair of support portions 24a and 24b to be supported thereby, while the barrel nipple 19 which is fixed on an end of the drive cable 18 (or 17) led to the lower cable-end hook portion 26 from above is engaged in the pair of support portions 26a and 26b to be supported thereby. At this time, one end (the left end as viewed in FIG. 10) of each barrel nipple 19 is fitted into the associated outer support hole 24c (or 26c) through the inner support hole 24d (or 26d). The other end of each barrel nipple 19 is properly engaged in the associated inner support hole 24d at the same time. In this state where the opposite ends of each barrel nipple 19 are engaged in the outer support hole 24c (or 26c) and the inner support hole 24d (or 26d) of the associated cable-end holding portion 23, respectively, the barrel nipple 19 is rotated clockwise or counterclockwise about the common axis of the outer support hole 24c (or 26c) and the inner support hole 24d (or 26d) so that the first drive cable 17 and the second drive cable 18 contact the semi-cylindrical surface 43 and press the semi-cylindrical surface 43 toward the associated guide rail 10 while intersecting each other thereon (see FIG. 2), as viewed in a direction of the thickness of the tailgate (in a direction orthogonal to the page in FIG. 1). Such pressure by the first drive cable 17 and the second drive cable 18 against the semi-cylindrical surface 43 brings the contacting surface 42 of each cable guide piece 40 into pressing contact with the root portion 25a of the associated synthetic piece holding portion 25. At this time, the engagement of the end portion 25b of the synthetic piece holding portion 25 in the bottomed engaging hole 41 of the cable guide piece 40 prevents each cable guide piece 40 from coming off the associated synthetic piece holding portion 25 in a direction perpendicular to outer and inner surfaces of the window glass W.

Each cable protection cover 19a prevents that bare portion of the drive cable 17 or 18 adjacent to the cable protection cover 19a from contacting with the associated slider base 20 which is made of metal. When each barrel nipple 19 is inserted into the upper cable-end hook portion 24 (or the lower cable-end hook portion 26) through the inner support hole 24d (or the inner support hole 26d), there is a high possibility of the cable protection cover 19a contacting the upper cable-end hook portion 24 (or the lower cable-end hook portion 26) which has a substantially U-shape cross section. In a conventional drive cable which is provided, adjacent to the barrel nipple fixed on each end of the drive cable, with no member corresponding to the cable protection cover 19a, there is a high possibility of that bare portion of the drive cable adjacent to the barrel nipple contacting with the upper cable-end hook portion 24 or the lower cable-end hook portion 26 and getting damaged. In contrast to such a conventional drive cable, the above-mentioned bare portion of the drive cable 17 or 18 adjacent to the barrel nipple 19 on each end of the drive cable is covered by the cable protection cover 19a, and is therefore prevented from being scratched and damaged even if the cable protection cover 19a contacts with the upper cable-end hook portion 24 (or the lower cable-end hook portion 26). Accordingly, no scratches are made on either the first drive cable 17 or the second drive cable 18 during assembly of the cable-operated window regulator, so that the durability of each of the first drive cable 17 and the second drive cable 18 is not decreased over the long term.

Since the respective positions of the upper cable-end hook portion 24 and the lower cable-end hook portion 26 are offset from each other in a direction perpendicular to outer and inner surfaces of the window glass W (horizontal direction as viewed in FIG. 5), the first drive cable 17 and the second drive cable 18 contact with the semi-cylindrical surface 43 at different positions thereon, and therefore do not contact each other. In addition, when each barrel nipple 19 is put in the upper cable-end hook portion 24 or the lower cable-end hook portion 26, the first drive cable 17 and the second drive cable 18 are prevented from contacting with any part of each slider base 20 even though each cable protection cover 19a contacts the associated slider base 20. Therefore, in the present embodiment of the cable-operated window regulator, respective bare portions of the first drive cable 17 and the second drive cable 18 can be prevented from being scratched and damaged during assembly of the cable-operated window regulator. This prevents the first drive cable 17 and the second drive cable 18 from rusting and therefore prevents the durability of each of the first drive cable 17 and the second drive cable 18 from being decreased over the long term.

From the viewpoint of production of the first drive cable 17 and the second drive cable 18, each barrel nipple 19 and the associated cable protection cover 19a can be simultaneously formed on each end of either drive cable 17 or 18 by insertion molding. Accordingly, each of the first drive cable 17 and the second drive cable 18, which are provided on each cable end thereof with one barrel nipple 19 and one cable protection cover 19a, can be produced at a lower cost than a drive cable which is produced according to a conventional method of increasing the mechanical strength of the joint between a barrel nipple and the associated end of the drive cable (on which the barrel nipple is fixed) by swaging a peripheral end of the barrel nipple.

In an assembled state of the cable-operated window regulator shown in FIG. 1, rotating the winding drum 16a in forward and reverse directions by the reversible motor 16b causes the first drive cable 17 to be reeled on and off the winding drum 16a on one side of the first drive cable 17, and at the same time, causes the first drive cable 17 to be reeled off and on the winding drum 16a on the other side of the first drive cable 17, respectively. This causes the pair of slider bases 20, each of which includes the slider 30 having the sliding portion 34 that is slidably guided by the associated guide rail 10 to be freely movable there along, to move up or down simultaneously in the same direction to raise and lower the window glass W which is fixed to the pair of slider bases 20. During this movement of the window glass W, each slider 30 is acted upon by a force to move the slider 30 away from the associated slider base 20 because the slider holding surface 22 and the upper cable-end hook portion 24 (the drive cable 17 or 18) are horizontally offset from each other while the slider holding surface 22 and the lower cable-end hook portion 26 (the drive cable 17 or 18) are horizontally offset from each other. However, each slider 30 easily bears such a force because each slider 30 has the pair of reinforcement ribs 33, which extend along the associated slider holding surface 22, and the hook portion 32 which is engaged with an upper edge of the associated slider holding surface 22.

In the above described embodiment of the cable-operated window regulator, each of the first drive cable 17 and the second drive cable 18 is provided, on each of the opposite end portions thereof in the vicinity of the upper cable-end hook portion 24 or the lower cable-end hook portion 26 (i.e., portions which may be easily scratched and damaged), with one barrel nipple 19 and one cable protection cover 19a. In the case where the first drive cable 17 is composed of two cables: a first cable extending between the left slider base 20 and the winding drum 16a, and a second cable extending between the right slider base 20 and the winding drum 16a, it is desirable that each of the first cable and the second cable be provided, not only at one end thereof in the vicinity of the upper cable-end hook portion 24 or the lower cable-end hook portion 26 but also at the other end fixed to the winding drum 16a, with one barrel nipple 19 and one cable protection cover 19a. With this structure, either end of each of the first cable and the second cable of the first drive cable 17 can be fixed to the upper cable-end hook portion 24 on the right slider base 20 or the lower cable-end hook portion 26 on the left slider base 20, or the winding drum 16a. This not only facilitates assembly of the cable-operated window regulator but also prevents each of the first and second cables of the first drive cable 17 from being scratched and damaged when each of the first and second cables of the first drive cable 17 is fixed to the winding drum 16a.

The cable-operated window regulator according to the present invention can be applied not only to a tailgate of a vehicle in a manner like the above described embodiment of the cable-operated window regulator, but also to a side door of a vehicle. In the case where the cable-operated window regulator according to the present invention is applied to a side door of a vehicle, the pair of guide rails 10 are positioned at front and rear positions (or rear and front positions) of the vehicle; nevertheless, the pair of guide rails 10 are positioned apart from each other in a widthwise direction of a door or a gate of the vehicle in either case.

Although each slider base 20 is supported by the associated guide rail 10 to be freely movable there along in the above described embodiment of the cable-operated window regulator, it is possible that a pair of slider bases 20 be supported by only the pair of upper guide pulleys 13 and the pair of lower guide pulleys 14, each pair of which are apart from each other in a widthwise direction of the tailgate, without the use of the pair of guide rails 10. This arrangement is also possible to apply the present invention. Namely, providing the cable-operated window regulator with each guide rail 10 or the guide pulley 13 or 14 fixed in the vicinity of each end of each guide rail 10 to guide each slider base 20 in a vertical direction is not an essential condition to apply the present invention. In the case where each slider base 20 is not supported by the associated guide rail 10 (i.e., in the case of using no guide rails 10), any other guide device for guiding the window glass W can be used. Although the window glass W is fixed directly to each slider base 20 in the above illustrated embodiment of the cable-operated window regulator, the window glass W can be fixed to each slider base 20 via a bracket or the like.

The drive cable devised according to the present invention such as the first drive cable 17 or the second drive cable 18 of the above described embodiment of the cable-operated window regulator can be used not only as an element of a cable-operated window regulator, but also but also as an element of any other device to serve as a flexible device for transferring power to a driven member. As described above, the drive cable devised according to the present invention can be used as an element of a mechanism such as a cable-operated window regulator or a lock (e.g., a door lock, a hood lock, a back door or a tailgate) in the field of vehicle.

As can be understood from the foregoing, according to an aspect of the present invention, a drive cable having a barrel nipple at one end or each end of the drive cable, wherein a portion of the drive cable adjacent to the barrel nipple is prevented from being damaged, is achieved. Additionally, according to another aspect of the present invention, a cable-operated window regulator which is constructed to prevent the bare cable portion of one or more than one drive cable of the cable-operated window regulator from being damaged to thereby increase durability of the cable-operated window regulator, is achieved.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A drive cable comprising:
a barrel nipple fixed on an end of said drive cable, wherein an axis of said barrel nipple extends in a direction perpendicular to a longitudinal direction of said drive cable; and
a cable protection cover which covers a portion of said drive cable adjacent to said barrel nipple,
wherein said barrel nipple and said cable protection cover are formed integral with each other.

2. The drive cable according to claim 1, wherein said cable protection cover comprises a cylindrical portion fitted on said drive cable.

3. The drive cable according to claim 2, wherein said cylindrical portion comprises:
a first cylindrical portion formed integral with said barrel nipple; and
a second cylindrical portion formed integral with said first cylindrical portion to be positioned on the opposite side of said first cylindrical portion from said barrel nipple,
wherein a diameter of said second cylindrical portion is smaller than a diameter of said first cylindrical portion.

4. The drive cable according to claim 1, wherein said barrel nipple and said cable protection cover are formed on said one end of said drive cable by insertion molding.

5. The drive cable according to claim 1, wherein said barrel nipple and said cable protection cover are made of metal.

6. The drive cable according to claim 1, wherein said drive cable comprises a twisted steel wire.

7. A cable-operated window regulator for a vehicle comprising:
a slider base fixed to a window glass;
a cable-end holding portion formed on said slider base;
a drive cable, one end of which is supported by said cable-end holding portion, said drive cable extending from said cable-end holding portion to a cable guide member;
a barrel nipple fixed on said one end of said drive cable, wherein an axis of said barrel nipple extends in a direction perpendicular to a longitudinal direction of said drive cable; and
a cable protection cover which covers a portion of said drive cable adjacent to said barrel nipple,
wherein said cable-end holding portion includes a barrel nipple support portion which holds opposite ends of said barrel nipple, and
wherein said barrel nipple and said cable protection cover are formed integral with each other.

8. The cable-operated window regulator according to claim 7, wherein said cable-end holding portion comprises a pair of parallel support portions which are formed by bending a metal portion of said cable-end holding portion to have a substantially U-shape cross section, and
wherein said pair of parallel support portions serve as said barrel nipple support portion to hold said opposite ends of said barrel nipple, respectively.

9. The cable-operated window regulator according to claim 7, wherein said barrel nipple support portion comprises at least two barrel nipple support portions which are offset from each other in a direction perpendicular to outer and inner surfaces of said window glass.

10. The cable-operated window regulator according to claim 7, wherein said cable protection cover comprises a cylindrical portion fitted on said drive cable.

11. The cable-operated window regulator according to claim 10, wherein said cylindrical portion comprises:
a first cylindrical portion formed integral with said barrel nipple; and
a second cylindrical portion formed integral with said first cylindrical portion to be positioned on the opposite side of said first cylindrical portion from said barrel nipple,
wherein a diameter of said second cylindrical portion is smaller than a diameter of said first cylindrical portion.

12. The cable-operated window regulator according to claim 7, wherein a pair of coaxial holes are formed on said barrel nipple support portion, said opposite ends of said barrel nipple being fitted in said pair of coaxial holes, respectively, so that said barrel nipple can rotate freely about an axis of said pair of coaxial holes.

13. The cable-operated window regulator according to claim 7, wherein said cable guide member comprises a pulley.
